(19) United States
(12) Patent Application Publication
(10) Pub. No.: US 2026/0136099 A1
(43) Pub. Date: May 14, 2026

(54) DYNAMIC MOTION COMPENSATED TEMPORAL FILTERING (MCTF) FOR VIDEO PROCESSING

(71) Applicant: QUALCOMM Incorporated, San Diego, CA (US)

(72) Inventors: Swapnesh Kumar Sahoo, Bengaluru (IN); Murari Prabhakar Alawandi, Bengaluru (IN); Animesh Behera, Bengaluru (IN); Tauseef Kazi, San Diego, CA (US); Aravind Bhaskara, San Diego, CA (US); Nitin Bandwar, San Diego, CA (US); Praveen Sekar, Bangalore (IN)

(21) Appl. No.: 18/941,478

(22) Filed: Nov. 8, 2024

(51) Int. Cl. H04N 23/68; H04N 19/117; H04N 19/139; H04N 19/172; H04N 19/567

(52) U.S. Cl. CPC H04N 23/6811; H04N 19/117; H04N 19/139; H04N 19/172; H04N 19/567; H04N 23/683

(57) ABSTRACT

A video processing device may obtain a current picture of video data; determine a noise level in the current picture; and selectively apply Motion Compensated Temporal Filtering (MCTF) to the current picture based on the noise level.

### TECHNICAL FIELD

This disclosure relates to video processing.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures.

### SUMMARY

In general, this disclosure describes techniques for processing video data, including techniques for Motion Compensated Temporal Filtering (MCTF). In particular, this disclosure describes active noise characteristics based dynamic MCTF processing.

In one example, the video processing device may continuously evaluate the level of noise present in each picture of video data. The video processing device may employ a noise stats unit that may operate in parallel with an existing picture processing pipeline. The noise stats block may analyze the input picture to determine the overall level of noise present in the picture. As one example, the video processing device may dynamically adjust the portions and rate of MCTF processing based on the noise characteristics, optimizing efficiency and performance.

The video processing device may use a first control input signal to control the activation of the temporal processing blocks within the MCTF pipeline. The video processing device may use a second control signal to control whether the reference picture is written to memory. By selectively activating the first control signal and second control signal the video processing device may dynamically adapt the level of MCTF processing based on the noise characteristics of the current picture. In some examples, the primary function of the noise stats unit may be to analyze the current picture and determine the appropriate level of MCTF processing based on the active noise characteristics or noise profile. In one example, the noise stats unit may determine the spatial distribution of noise within the picture.

In still another example, the noise stats unit may determine the presence of artifacts caused by motion blur or other factors that may mimic noise (ghosting). Furthermore, if ghosting is detected, the noise stats unit may adjust the temporal filtering parameters to minimize impact of the ghosting.

By selectively applying MCTF processing based on noise characteristics of the pictures, the video processing device may reduce computational overhead and power consumption.

In one example, this disclosure describes a method for processing video data at a capture device, the method comprising: obtaining a current picture of video data; determining a noise level in the current picture; and selectively applying Motion Compensated Temporal Filtering (MCTF) to the current picture based on the noise level.

In another example, an apparatus configured to process video data includes a memory; and processing circuitry in communication with the memory. The processing circuitry is configured to obtain a current picture of video data. The processing circuitry is also configured to determine a noise level in the current picture; and selectively apply Motion Compensated Temporal Filtering (MCTF) to the current picture based on the noise level.

In yet another example, non-transitory computer-readable storage media having instructions encoded thereon, the instructions configured to cause processing circuitry to: obtain a current picture of video data. Additionally, the instructions are configured to cause processing circuitry to determine a noise level in the current picture; and selectively apply Motion Compensated Temporal Filtering (MCTF) to the current picture based on the noise level.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example MCTF processing unit in accordance with the techniques of this disclosure.

FIG. 3 is a block diagram illustrating an example noise stats unit that may perform the techniques of this disclosure.

FIG. 4 is a sequence diagram illustrating example state transitions of the noise stats unit of FIG. 3 in accordance with the techniques of this disclosure.

FIG. 5 is a diagram illustrating an alternate implementation of the noise stats unit of FIG. 3 where control signal switching is deterministic in accordance with the techniques of this disclosure.

FIG. 6 is a flowchart illustrating an example process at a video processing device in accordance with the techniques of this disclosure.

### DETAILED DESCRIPTION

Motion Compensated Temporal Filtering (MCTF) is an image processing technique for reducing noise in captured video and improving overall picture quality. As used herein, the term “noise” refers to unwanted variations in pixel intensity that may degrade picture quality. One example MCTF technique first estimates the motion between consecutive pictures of the video. Such estimation may be done by analyzing the pixel-by-pixel differences between the pictures. Once the motion is estimated, the example MCTF approach applies a temporal filter to blend information from multiple pictures. This MCTF approach helps to reduce noise and improve picture quality. The filtered pictures may then be combined to create the final, noise-reduced output picture.

A generic implementation of MCTF may include two primary units: a spatial NR (Noise Reduction) unit and a temporal filter unit.

The spatial NR unit applies spatial filtering techniques to reduce noise caused by factors like sensor imperfections or low light conditions. As such, the spatial NR unit may be implemented in hardware (e.g., dedicated noise reduction circuits) or software (e.g., using algorithms like median filtering or Gaussian filtering).

The temporal filter unit performs inter-picture blending, combining information from the current picture with a reference picture. The temporal filter uses the estimated motion information to align the pictures and then blends them together to reduce noise and improve stability. The temporal filter unit may also be implemented in hardware or software. Common techniques include linear blending, weighted averaging, and block matching motion compensation (BMAC).

In some example MCTF implementations by a video processing device, an input picture is first processed by the spatial noise reduction unit to reduce intra-picture noise. A motion estimation unit may estimate the motion between the current picture and the reference picture. The temporal filter unit uses the motion information to align the pictures and blend them together. A blended picture is the final output picture after the conventional MCTF filtering process.

The blended picture represents the noise-reduced and temporarily stabilized picture. The blended picture may be further processed using additional techniques like color correction, sharpening, or compression. The blended picture may also be used as the reference picture for the processing of a next picture, creating a continuous filtering process throughout the video. The reference picture once again is compared to the current picture to estimate motion. A video processing device may further employ an alignment unit, which may be another component used in the implementation of MCTF. The alignment unit uses the motion estimation data to adjust the reference picture to match the position of the current picture. The alignment unit ensures that corresponding pixels in the two pictures are aligned correctly for effective blending.

In summary, the example MCTF process described above involves spatial noise reduction on the current picture and motion estimation between the current picture and the previous picture (reference picture). The example MCTF process further involves alignment of the reference picture to match the current picture and temporal filtering to blend the aligned pictures and reduce noise.

This disclosure describes techniques to improve the efficiency of MCTF by dynamically adjusting the processing intensity based on the actual noise levels in the picture. Example techniques of this disclosure may significantly reduce bandwidth and power consumption while maintaining noise filtering. As used herein, the term “noise level,” refers to the overall amount of noise present in a picture. The noise level may be measured as a Signal-to-Noise Ratio (SNR) or a Noise Equivalent Exposure (NEE). A higher SNR or lower NEE indicates less noise in the image.

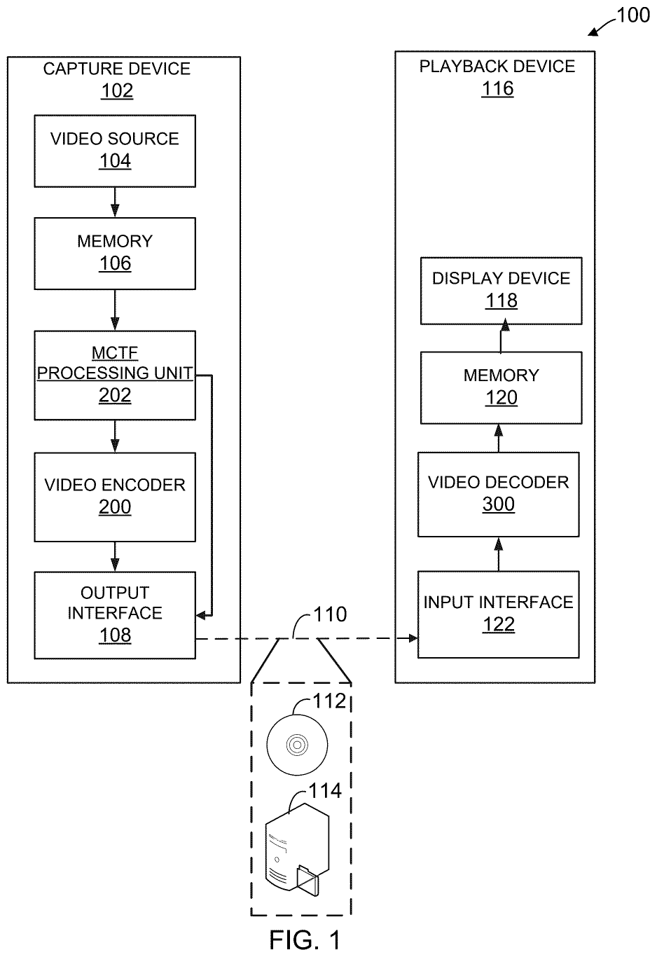

FIG. 1 is a block diagram illustrating an example video encoding and decoding system 100 that may perform the techniques of this disclosure. The techniques of this disclosure are generally directed to coding (encoding and/or decoding) video data as well as processing video data. In general, video data includes any data for processing a video. Thus, video data may include raw, unencoded video, encoded video, decoded (e.g., reconstructed) video, and video metadata, such as signaling data.

As shown in FIG. 1, system 100 includes a capture device 102 that provides encoded video data to be decoded and displayed by a playback device 116, in this example. In particular, capture device 102 provides the video data to playback device 116 via a computer-readable medium 110. Capture device 102 and playback device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, capture device 102 and playback device 116 may be equipped for wireless communication, and thus may be referred to as wireless communication devices.

In the example of FIG. 1, capture device 102 includes video source 104, memory 106, video encoder 200, MCTF processing unit 202, and output interface 108. Playback device 116 includes input interface 122, video decoder 300, memory 120, and display device 118. In other examples, a capture device and a playback device may include other components or arrangements. For example, capture device 102 may receive video data from an external video source, such as an external camera. Likewise, playback device 116 may interface with an external display device, rather than include an integrated display device.

System 100 as shown in FIG. 1 is merely one example. In general, any video processing device may perform techniques for MTCF processing. Capture device 102 is merely an example of such processing devices in which capture device 102 generates coded video data, including processing video using the MCTF techniques of this disclosure, for transmission to playback device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, capture device 102 and playback device 116 may operate in a substantially symmetrical manner such that each of capture device 102 and playback device 116 includes video encoding and decoding components. Hence, system 100 may support one-way or two-way video transmission between capture device 102 and playback device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of capture device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Capture device 102 may then output the encoded video data via output interface 108 onto computer-readable medium 110 for reception and/or retrieval by, e.g., input interface 122 of playback device 116.

Memory 106 of capture device 102 and memory 120 of playback device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from capture device 102 to playback device 116. In one example, computer-readable medium 110 represents a communication medium to enable capture device 102 to transmit encoded video data directly to playback device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from capture device 102 to playback device 116.

In some examples, capture device 102 may output encoded data from output interface 108 to storage device 112. Similarly, playback device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, capture device 102 may output encoded video data to file server 114 or another intermediate storage device that may store the encoded video data generated by capture device 102. Playback device 116 may access stored video data from file server 114 via streaming or download.

File server 114 may be any type of server device capable of storing encoded video data and transmitting that encoded video data to the playback device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Playback device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, capture device 102 and/or playback device 116 may include respective system-on-a-chip (SoC) devices. For example, capture device 102 may include an SoC device to perform the functionality attributed to video encoder 200 and/or output interface 108, and playback device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of playback device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use MCTF processing.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra picture prediction or spatial prediction) and inter prediction (e.g., inter picture prediction or temporal prediction). In the context of AV1, when predicting blocks of a current picture of video data using an intra prediction mode, video encoder 200 and video decoder 300 do not use video data from other pictures of video data. For most intra prediction modes, video encoder 200 encodes blocks of a current picture based on the difference between sample values in the current block and predicted values generated from reference samples in the same picture. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

Any of the video encoding or video decoding processes described above may be performed using a neural network (NN). Additionally or alternatively, a neural network may be trained to efficiently compress video data without necessarily separately performing prediction and residual coding. Studies have shown that embedding neural networks into the hybrid video coding framework of video encoder 200 and video decoder 300 can improve compression efficiency. Neural networks may be used for intra prediction and inter prediction to improve the prediction efficiency. NN-based in-loop filtering and/or post-filtering have also performed well in heuristic testing.

For example, video encoder 200 and video decoder may use one or more NN-based filters for existing filters, such as deblocking filters, sample adaptive offset (SAO), and/or adaptive loop filtering (ALF). NN-based filters can also be applied exclusively, where NN-based filters are designed to replace all of the existing filters. Additionally or alternatively, NN-based filters may be designed to supplement, enhance, or replace any or all of the other filters.

In some examples, an NN-based filter may be a convolutional neural network (CNN)-based filter with multiple layers. An NN-based filtering process may take reconstructed samples as inputs, and may add the intermediate outputs back to the inputs to refine the input samples. The NN-based filter may use all color components (e.g., Y, U, and V, or Y, Cb, and Cr) as inputs 172 to exploit cross-component correlations. Different color components may share the same filters (including network structure and model parameters) or each component may have its own specific filters.

The filtering process can also be generalized as follows:

$${R}^{′} ( i , j ) = R ( i , j ) + NN\_filter \_residual \_ouput ( R )$$

Here, R(i, j) represents a reconstructed sample at position (i, j) in the picture, R′(i, j) represents the filtered version of the reconstructed sample, and NN_filter_residaul_output(R) represents the intermediate samples discussed above that are calculated by the NN filter. The model structure and model parameters of NN-based filter(s) can be pre-defined and be stored at video encoder 200 and video decoder 300. The filters can also be signaled in the bitstream.

In some examples, an NN-based filter may include a series of feature extraction layers, followed by an output convolution. The feature extraction layers may include a 3×3 convolution (conv) layer followed by a parametric rectified linear unit (PReLU) layer. The convolutional layer applies a convolution operation to the input data, which involves a filter or kernel processing the input data (e.g., the reconstruction samples) in a sliding window fashion and computing dot products at each position. The convolution operation essentially captures local patterns within the input data. For example, in the context of picture processing, these patterns could be edges, textures, or other visual features. The filter or kernel is a small matrix of weights that gets updated during the training process. By sliding this filter across the input data (or feature map from a previous layer) and computing the dot product at each position, the convolutional layer creates a feature map that encodes spatial hierarchies and patterns detected in the input. The output of a convolutional layer is a set of feature maps, each corresponding to one filter, capturing different aspects of the input data. This layer helps the neural network to learn increasingly complex and abstract features as the data passes through deeper layers of the network.

The PReLU layer is an activation function used in neural networks, and is a variant of the ReLU (Rectified Linear Unit) activation function. As described above, the convolution layer outputs feature maps, each corresponding to one filter, representing detected features in the input. Following the convolution layer, the PReLU layer applies the PReLU activation function to each element of the feature maps produced by the convolution layer. For positive values, the PReLU layer acts like a standard ReLU, passing the value through. For negative values, instead of setting them to zero (e.g., as ReLU does), the PReLU layer allows a small, linear, negative output. This keeps neurons of the NN active and maintains the gradient flow, which can be beneficial for learning in deep networks.

When NN-based filtering is applied in video coding, the whole video signal (pixel data) may be split into multiple processing units (e.g., 2D blocks), and each processing unit can be processed separately or be combined with other information associated with this block of pixels. For example, a processing unit may be a picture, a slice/tile, a CTU, or any pre-defined or signaled shapes and sizes. Typically, NN-based filtering is performed on reconstructed blocks of video data. Here, reconstructed blocks and samples may refer to both decoded blocks produced by video decoder 300, as well blocks reconstructed in a reconstruction loop of video encoder 200.

To further improve the performance of NN-based filtering, different types of input data can be processed jointly to produce the filtered output. Input data may include, but is not limited to, reconstruction pixels/samples, prediction pixels/samples, pixels/samples after the loop filter(s), partitioning structure information, deblocking parameters (e.g., boundary strength (BS)), quantization parameter (QP) values, slice or picture types, or a filters applicability or coding modes map. Input data can be provided at different granularities. Luma reconstruction and prediction samples may be provided at the original resolution, whereas chroma samples may be provided at lower resolution, e.g., for 4:2:0 representation, or can be up-sampled to the Luma resolution to achieve per-pixel representation. Similarly, QP, BS, partitioning, or coding mode information can be provided at lower resolution, including cases with a single value per picture, slice or processing block (e.g., QP). In other examples, QP, BS, partitioning, or coding mode information can be expanded (e.g., replicated) to achieve per-pixel/sample representation.

To further improve the performance of NN-based filtering, multi-mode solutions can be used. For example, for each processing unit, video encoder 200 may select a mode from a set of modes based on rate-distortion optimization and signal the selected mode in the bit-stream. The different modes may include different NN models, different values that may be used as the input information of the NN models, etc. In one example, video encoder 200 and video decoder 300 may use an NN-based filtering solution with multiple modes based on a single NN model by using different QP values as input to the NN model for different modes.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, capture device 102 may transport the bitstream to playback device 116 substantially in real time, or not in real time, such as might occur when storing syntax elements to storage device 112 for later retrieval by playback device 116.

As shown in FIG. 1, capture device 102 may further include a MCTF processing unit 202. When capture device 102 (e.g., a camera) records video, capture device 102 may employ MCTF processing unit 202 to compare the current picture to the previous picture (reference picture), identifying areas of motion. By comparing the reference picture to the actual captured picture, MCTF processing unit 202 may identify and reduce noise, artifacts, or inconsistencies. Accordingly, MCTF processing may lead to a cleaner, more visually appealing video.

Some example MCTF approaches operate “blindly.” In other words, some example MCTF approaches apply the filtering process for every picture. Such blind MCTF approach may lead to suboptimal results, especially in scenes with varying noise levels. Such example MCTF approaches are simple to implement. However, these approaches may introduce artifacts or degrade picture quality in certain scenarios, particularly when noise levels are high or vary significantly. Constant processing may lead to higher power consumption, especially in battery-powered devices.

In view of these drawbacks, this disclosure describes techniques that facilitate improvement upon the limitations of blind MCTF processing by dynamically enabling or disabling the filtering process based on the active noise characteristics of the current picture. The disclosed techniques offer greater flexibility and may potentially achieve better results. As such, in accordance with the techniques of this disclosure which will be explained in more detail below, MCTF processing unit 202 may include a noise stats unit that may be used to analyze the current picture and determine noise level or characteristics of the current picture. The noise stats unit may provide a more detailed numerical analysis of the noise characteristics. In one example, the noise stats unit may perform the picture analysis using various techniques, such as, but not limited to, statistical analysis or deep learning-based methods. Based on the estimated noise level, MCTF processing unit 202 may determine whether to apply MCTF processing.

As explained in more detail below, if the noise level is deemed to be low, MCTF processing unit 202 may disable MCTF processing. Conversely, if the noise level is high, MCTF processing unit 202 may enable MCTF processing to reduce impact of the noise. As such, when MCTF is enabled, the MCTF filtering parameters may be adjusted dynamically by MCTF processing unit 202 based on the estimated noise characteristics. Adaptive filtering may allow for more tailored noise reduction and artifact suppression.

In particular, by adapting MCTF to the specific noise conditions of each picture, MCTF processing unit 202 may potentially achieve better picture quality compared to blind MCTF processing. By selectively applying MCTF, processing costs may be reduced, especially in scenes with low noise levels.

For example, in the context of video processing, the actual power savings of capture device 102 may vary between 2% and 7%. The efficiency gains may be even more significant when video processing tasks are implemented on programmable cores. The programmable cores provide greater control and customization, allowing for more targeted optimizations that may lead to substantial reductions in power consumption. Examples of programmable cores include, but are not limited to, CPUs, GPUs, and neural network-based accelerators.

As such, in accordance with the techniques of this disclosure which will be explained in more detail below, capture device 102 may be configured to obtain a current picture of video data. The capture device 102 may determine a noise level in the current picture. Next, the capture device 102 may selectively apply Motion Compensated Temporal Filtering (MCTF) to the current picture based on the noise level.

In a reciprocal fashion, playback device 116 may receive encoded video data, decode the encoded video data to generate a decoded picture.

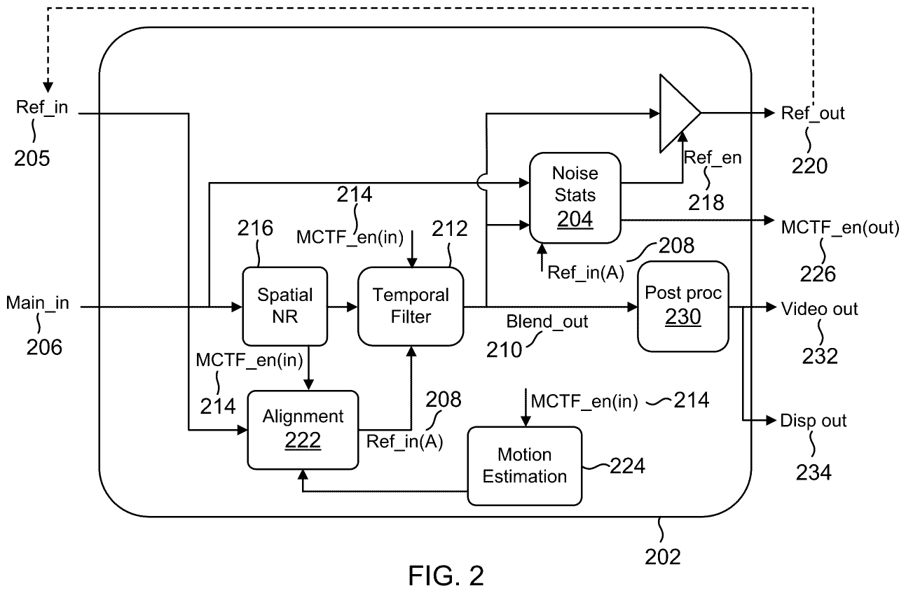

FIG. 2 is a block diagram illustrating an example MCTF processing unit 202 in accordance with the techniques of this disclosure.

In accordance with the disclosed techniques, MCTF processing unit 202 may periodically evaluate the level of noise present in a picture. In one example, based on the noise assessment, MCTF processing unit 202 may selectively apply MCTF processing to specific regions of the picture. In other examples, pictures with high noise levels may receive more intensive processing, while pictures with low noise may require minimal or no MCTF processing. In general, MCTF processing unit 202 may also adjust the processing rate, such as reducing the frequency of MCTF updates when noise levels are low.

In accordance with the disclosed techniques, less processing may be required during dynamic MCTF processing, leading to lower power consumption, especially in battery-powered devices. MCTF processing unit 202 may ensure that noise filtering is applied effectively where the filtering is needed most, while minimizing unnecessary processing. By tailoring the MCTF processing to the specific noise characteristics of each picture, MCTF processing unit 202 may achieve better overall picture quality.

The MCTF processing unit 202 illustrated in FIG. 2 may include noise stats unit 204 that may operate in parallel with the MCTF pipeline. Noise stats unit 204 may provide information about the noise characteristics of the picture, which may be used to optimize the MCTF processing. The inputs to the noise stats unit 204 may include: Main_in 206, Ref_in(A) 208, Blend_Out 210 and noise threshold. Main_in 206 may be the current picture being processed. Ref_in(A) 210 may be the aligned reference picture (the reference picture that passed through the alignment unit). Blend_Out 210 may be the output of the temporal filter unit 212. Noise threshold may be a programmable threshold that may be adjusted based on lighting conditions (e.g., lux dependent).

Noise stats unit 204 may analyze the input pictures (e.g., Main_in 206) to determine the overall level of noise present in the picture. Noise stats unit 204 may also determine the distribution of noise within the picture (e.g., concentrated in certain areas or evenly spread). In one example, noise stats unit 204 may determine the type of noise (e.g., Gaussian, salt-and-pepper, etc.). By providing noise information, noise stats unit 204 may help the MCTF processing unit 202 make more informed decisions about when and where to apply MCTF processing.

The MCTF_en signal 214 may control the activation of the temporal processing blocks within the MCTF pipeline. In one example, MCTF_en signal 214 having value equal to 0 may turn off temporal processing performed by temporal filter unit 212. In this case, only spatial noise reduction (performed by spatial NR unit 216) may be applied. In one example, MCTF_en signal 214 having value equal to 1 may turn on temporal processing performed by temporal filter unit 212. In this case, both spatial noise reduction and temporal filtering may be active.

In the example illustrated in FIG. 2, the Ref_en input signal 218 may control whether the reference picture (Ref_out 220) is written to memory (e.g., DDR (Double Data Rate) memory). In one example, Ref_en signal 218 having value equal to 0 may disable writing to memory. The next picture may use the last available Ref_in 205. In one example, Ref_en signal 218 having value equal to 1 may enable writing to memory. In this case, MCTF processing unit 202 may store the current Ref_out 220 for future use as the reference picture (Ref_in 205).

By controlling MCTF_en signal 214 and Ref_en signal 218, MCTF processing unit 202 may dynamically adapt the level of MCTF processing based on the noise characteristics of the picture. If the noise level is low, temporal processing may be disabled (MCTF_en=0) to save computational resources. As noted above, Ref_en signal 218 may control whether the reference picture is stored for future use. Ref_en signal 218 may be useful for maintaining a consistent reference over multiple pictures, especially in low-light conditions or when there are sudden changes in the scene.

In some examples, noise stats unit 204 may be configured to analyze the current picture and determine the appropriate level of MCTF processing based on the active noise characteristics or noise profile. Noise stats unit 204 may consider the overall intensity of noise in the picture. As will be discussed in more detail below, this noise level may be measured using various metrics, such as, but not limited to, edge/texture-aware sum of absolute differences (SAD). A noise profile describes the characteristics of the noise in a picture. The noise profile may include, but is not limited to factors like: color noise, luminance noise, spatial frequency, correlation. Color noise may include variations in color channels that may create unnatural color artifacts. Luminance noise may include variations in brightness levels that may make the picture appear grainy. Spatial frequency may indicate how noise is distributed across different frequencies in the picture. Correlation may indicate the degree to which noise patterns are correlated across neighboring pixels. In essence, noise profile describes the type of noise and the distribution of noise.

In another example, noise stats unit 204 may determine the spatial distribution of noise within the picture. In other words, noise stats unit 204 may determine if noise is concentrated in certain areas of the picture or evenly spread.

In yet another example, noise stats unit 204 may determine the type of noise present (e.g., Gaussian, salt-and-pepper, Poisson, among others). In still another example, noise stats unit 204 may determine the presence of artifacts caused by motion blur or other factors that can mimic noise (ghosting). Based on the noise profile, the noise stats unit 204 may determine whether to activate temporal filtering (MCTF_en signal 214=1) or disable the temporal filtering (MCTF_en signal 214=0). The noise stats unit 204 may also determine whether to store the reference picture (Ref_out 220) for future use. In accordance with the techniques of the present disclosure, if the noise level is significantly above a predefined threshold, noise stats unit 204 may activate both temporal filtering performed by temporal filter unit 212 and spatial noise reduction performed by spatial NR unit 216, and store the reference picture. If the noise level is low (e.g., below a threshold), noise stats unit 204 may disable temporal filtering and reduce the intensity of spatial noise reduction.

In one example, if ghosting is detected by noise stats unit 204, MCTF processing unit 202 may adjust the temporal filtering parameters to minimize impact of the ghosting. Examples of the temporal filtering parameters that may be adjusted include, but are not limited to, picture blend percentages (controls the weight given to each picture in the blending process), blend strength (indicates the overall intensity of the blending operation), and internal pixel difference thresholds (specifies the minimum pixel difference required for a pixel to be considered different between pictures). Ghosting may be a challenging problem in MCTF, as ghosting may mimic noise and degrade picture quality. In one example, noise stats unit 204 may help to identify and address ghosting by identifying motion patterns that may indicate ghosting.

In another example, noise stats unit 204 may identify and address ghosting by comparing the current picture with previous pictures to detect inconsistencies that could be attributed to ghosting. In still another example, noise stats unit 204 may address ghosting by modifying the aforementioned temporal filtering parameters to reduce the impact of ghosting.

Still referring to FIG. 2, this figure illustrates the enhanced MCTF techniques, which incorporate noise stats unit 204 to dynamically adjust the MCTF processing based on the noise characteristics of the current picture. As noted above, Main_in 206 may be the input picture. Spatial NR unit 216 is the unit that may perform spatial noise reduction within the picture. Temporal filter unit 212 is the unit that may perform inter-picture blending to reduce noise and improve stability.

In this example, alignment unit 222 may be a unit for aligning the reference picture (Ref_in 205) with the current picture (Main_in 206) based on motion estimation. In an aspect, alignment unit 222 may generate a motion vector matrix indicator. The motion vector matrix indicator may provide information about the motion between pictures. Temporal filter unit 212 may consume the motion vector matrix indicator for pre-blend motion compensation between consecutive pictures. The pre-blend motion compensation is a technique that may be used to align pictures before blending them together. This technique may help reduce artifacts caused by motion-induced discontinuities.

Motion estimation unit 224 is the unit that may estimate the motion between the current picture and the reference picture. As described above, noise stats unit 204 is a new unit that may analyze the noise characteristics of the current picture and may provide information for adaptive MCTF processing. MCTF_en(in) signal 214 and MCTF_en(out) signal 226 may be control signals for enabling or disabling temporal processing.

Ref_en input signal 218 may be a control signal for enabling or disabling writing the reference picture to memory. Ref_in(A) 228 may be the aligned reference picture. As described above, Blend_out 210 may be the output of the temporal filter unit 212, which may be the blended picture. Post processing (proc) unit 230 is a unit that may be configured to perform any additional post-processing steps (e.g., color correction, sharpening, etc.). Video out 232 may be the final output picture. Display (disp)out 234 may be the display output.

The MCTF_en signal 214 and Ref_en signal 218 may be controlled based on the output of the noise stats unit 204, enabling the MCTF processing unit 202 to optimize processing for different noise conditions. That is, by selectively applying MCTF processing and storing reference pictures only when necessary, MCTF processing unit 202 may reduce computational overhead and power consumption.

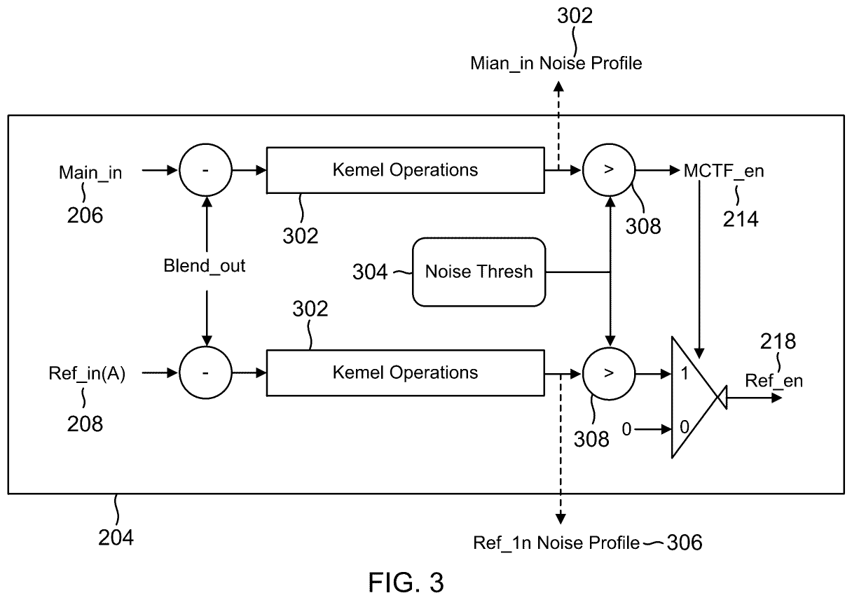

FIG. 3 is a block diagram illustrating an example noise stats unit 204 that may perform the techniques of this disclosure. In one example, noise stats unit 204 may be responsible for analyzing the noise characteristics of the current picture and determining a level of MCTF processing. Main_in noise profile 302 output may represent the noise profile of the current picture (Main_in).

In the illustrated example of noise stats unit 204, kernel operations unit 302 may be a set of operations that analyze the noise characteristics of the picture. In one example, kernel operations unit 302 may include edge/texture-aware sum of absolute differences (SAD) with ghosting detection.

In one example, MCTF_en signal 214 may be the output control signal that determines whether temporal filtering should be enabled or disabled. In some examples, noise threshold (thresh) parameter 314 may be a threshold value used to compare the noise level to a predefined limit.

In some examples, Ref_in noise profile 306 may be the noise profile of the reference picture (Ref_in) 208. As one example, kernel operations unit 302 may analyze the picture to extract features related to noise, such as, but not limited to, edge strength, texture information, and potential ghosting artifacts. In one example, the noise level extracted by the kernel operations unit 302 may be compared 308 to the noise threshold 304. If the noise level exceeds the threshold 305, the noise stats unit 204 may determine that MCTF processing is necessary.

For example, if the noise level is above the noise threshold 304, MCTF_en signal 214 may be set to 1, enabling temporal filtering. If the noise level is below the noise threshold 304, MCTF_en signal 214 may be set to 0, disabling temporal filtering.

The noise stats unit 204 may dynamically adjust the level of MCTF processing based on the actual noise characteristics of the picture.

By selectively applying MCTF processing only when necessary, MCTF processing unit 202 may reduce computational overhead and power consumption. Tailoring the MCTF processing to the specific noise characteristics may lead to better noise reduction and overall picture quality.

As discussed above temporal filtering performed by temporal filter unit 212 is a technique that processes picture sequences over time. Temporal filtering may be used to smooth out noise, detect motion, or enhance certain features.

In some examples, functions like SAD (Sum of Absolute Differences) and ghost-detect techniques from temporal filter unit 212 may be useful for noise stats unit 204. SAD may calculate the pixel-by-pixel difference between two consecutive pictures. SAD may be used to measure picture-to-picture variations, which may be indicative of noise.

The ghost detect technique may detect sudden, large changes in the picture, which could be caused by global or local motion spikes. By using these functions/techniques, noise stats unit 204 may potentially improve accuracy and reliability in measuring noise while limiting ghosting artifacts in the final blended picture.

In some examples, noise stats unit 204 may use a fixed processing rate for reference noise estimation. In other words, noise stats unit 204 may calculate a reference noise level at a regular interval, such as every N pictures. The value of N may be adjusted based on factors like lux (brightness) and motion. For example, in high-light conditions or with minimal motion, a larger N might be appropriate to capture a more accurate reference noise level. Conversely, in low-light conditions or with rapid motion, a smaller N might be better to avoid averaging out noise variations.

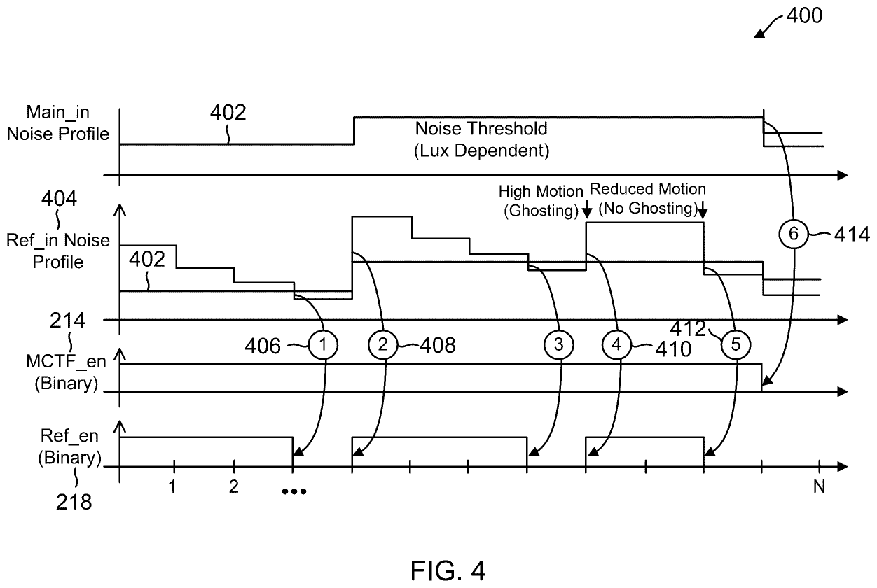

FIG. 4 is a sequence diagram illustrating an example state transitions of the noise stats unit of FIG. 3 in accordance with the techniques of this disclosure. FIG. 4 presents a sequence 400 of states or transitions, starting with a noisy picture and progressing through various scenarios. The illustrated sequence begins with a noisy picture, which may be the typical input for noise stats unit 204. As discussed above, MCTF_en signal 214 and Ref_en 218 may be signals that control the activation of certain processing steps within noise stats unit 204. The noise profile may indicate the level of noise present in the picture. The noise threshold 402 may be a threshold value that determines when the noise level is considered excessive.

When the noise profile 404 of the reference picture (Ref_in) 205 dips below the noise threshold 402 after MCTF processing (406), the noise profile 404 may suggest that the MCTF algorithm may be saturated. The saturation of the MCTF may occur in high-light conditions or with negligible motion. If low light introduces noise in the main input picture (Main_in 206) and the noise profile 404 rises above the noise threshold 402 (408), noise stats unit 204 may activate noise reduction techniques.

When ghosting artifacts are detected due to high motion (410), noise stats unit 204 may switch to a ghosting-aware filtering algorithm to mitigate these artifacts. If motion reduces (412), eliminating ghosting artifacts, noise stats unit 204 may revert to a regular filtering algorithm. If the input picture has low noise levels (414), noise stats unit 204 may disable certain processing steps or reduce their intensity.

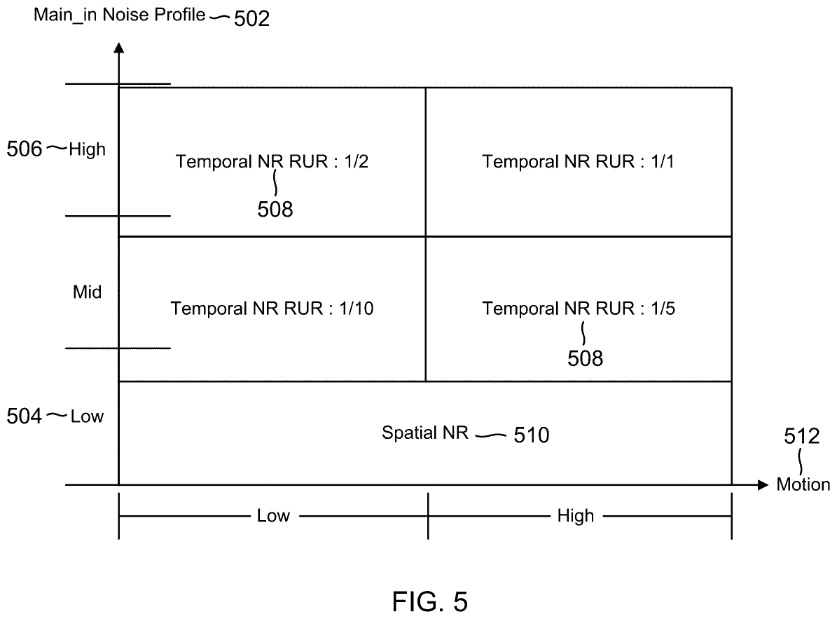

FIG. 5 is a diagram illustrating an alternate implementation of the noise stats unit of FIG. 3 where control signal switching is deterministic in accordance with the techniques of this disclosure. As shown in FIG. 5, the Main_in noise profile 502 may represent the perceived level of noise in the main input picture. That is, the Main_in noise profile 502 may range from low 504 to high 506. The RUR (Ref_in Update Rate) parameter 508 may control how frequently the reference picture is updated (e.g., once in 2 pictures). A lower RUR may mean the reference picture is updated less often, while a higher RUR may mean the reference picture is updated more frequently.

As discussed above the temporal noise reduction may implement a noise reduction algorithm that operates on the temporal dimension (i.e., over time). The spatial noise reduction unit 216 may implement a noise reduction algorithm 510 that operates on the spatial dimension (i.e., within the picture).

The diagram in FIG. 5 outlines a decision-making process based on the noise levels in the main picture and detected motion 512.

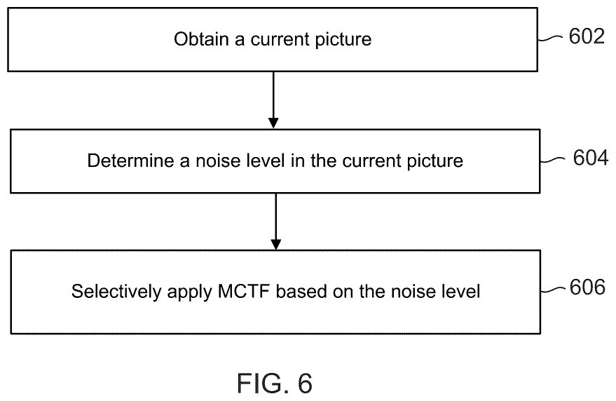

FIG. 6 is a flowchart illustrating an example process at a video processing device in accordance with the techniques of this disclosure. Although described with respect to capture device 102 (FIG. 1), it should be understood that other devices may be configured to perform a method similar to that of FIG. 6.

In this example, MCTF processing unit 202 of capture device 102 may initially obtain a current picture (Main_in 206) of video data (602). The MCTF processing unit 202 may determine a noise level in the current picture (604). In one non-limiting example, this noise level may be measured using various metrics, such as, but not limited to, edge/texture-aware sum of absolute differences (SAD). Next, MCTF processing unit 202 may selectively apply Motion Compensated Temporal Filtering (MCTF) to the current picture based on the noise level (606). In general, MCTF processing unit 202 may also adjust the processing rate, such as reducing the frequency of MCTF updates when noise levels are low.

The following numbered clauses illustrate one or more aspects of the devices and techniques described in this disclosure.

Aspect 1. A method for processing video data, the method comprising: obtaining a current picture of video data; determining a noise level in the current picture; and selectively applying Motion Compensated Temporal Filtering (MCTF) to the current picture based on the noise level.

Aspect 2. The method of Aspect 1, wherein selectively applying the MCTF further comprises: comparing the noise level in the current picture with a threshold; and applying the MCTF to the current picture, in response to determining that the noise level in the current picture is greater than the threshold.

Aspect 3. The method of Aspect 1, wherein selectively applying the MCTF to the current picture comprises: estimating motion data between the current picture and a reference picture; applying, based on the motion data, a temporal filter to generate a blended picture comprising information blended from the current picture and the reference picture; and outputting the blended picture.

Aspect 4. The method of Aspect 3, wherein selectively applying the MCTF to the current picture further comprises: aligning the current picture with the reference picture based on the motion data.

Aspect 5. The method of any of Aspects 1-4, wherein selectively applying the MCTF to the current picture further comprises: applying the MCTF to the current picture using one or more control signals.

Aspect 6. The method of Aspect 3, wherein estimating the motion data comprises: estimating the motion data using a sum of absolute difference (SAD) technique.

Aspect 7. The method of Aspect 3, wherein estimating the motion data comprises: identifying motion patterns indicating ghosting.

Aspect 8. The method of any of Aspects 1-7, wherein the noise level comprises a noise profile.

Aspect 9. An apparatus configured to process video data, the apparatus comprising: a memory; and processing circuitry in communication with the memory, the processing circuitry configured to: obtain a current picture of video data; determine a noise level in the current picture; and selectively apply Motion Compensated Temporal Filtering (MCTF) to the current picture based on the noise level.

Aspect 10. The apparatus of Aspect 9, wherein to selectively apply the MCTF to the current picture, the processing circuitry is further configured to: compare the noise level in the current picture with a threshold; and apply the MCTF to the current picture, in response to determining that the noise level in the current picture is greater than the threshold.

Aspect 11. The apparatus of Aspect 9, wherein to selectively apply the MCTF to the current picture, the processing circuitry is further configured to: estimate motion data between the current picture and a reference picture; apply, based on the motion data, a temporal filter to generate a blended picture comprising information blended from the current picture and the reference picture; and output the blended picture.

Aspect 12. The apparatus of Aspect 11, wherein to selectively apply the MCTF to the current picture, the processing circuitry is further configured to: align the current picture with the reference picture based on the motion data.

Aspect 13. The apparatus of any of Aspects 9-12, wherein to selectively apply the MCTF to the current picture, the processing circuitry is further configured to: apply the MCTF to the current picture using one or more control signals.

Aspect 14. The apparatus of Aspect 11, wherein to estimate the motion data, the processing circuitry is further configured to: estimate the motion data using a sum of absolute difference (SAD) technique.

Aspect 15. The apparatus of Aspect 11, wherein to estimate the motion data, the processing circuitry is further configured to: identify motion patterns indicating ghosting.

Aspect 16. The apparatus of any of Aspects 9-15, wherein the noise level comprises a noise profile.

Aspect 17. The apparatus of any of Aspects 9-16, further comprising a camera sensor configured to capture the current picture of the video data.

Aspect 18. Non-transitory computer-readable storage media having instructions encoded thereon, the instructions configured to cause processing circuitry to: obtain a current picture of video data; determine a noise level in the current picture; and selectively apply Motion Compensated Temporal Filtering (MCTF) to the current picture based on the noise level.

Aspect 19. The non-transitory computer-readable storage media of Aspect 18, wherein the instructions to selectively apply the MCTF to the current picture are further configured to cause the processing circuitry to: compare the noise level in the current picture with a threshold; and apply the MCTF to the current picture, in response to determining that the noise level in the current picture is greater than the threshold.

Aspect 20. The non-transitory computer-readable storage media of Aspect 18, wherein the instructions to selectively apply the MCTF to the current picture are further configured to cause the processing circuitry to: estimate motion data between the current picture and a reference picture; apply, based on the motion data, a temporal filter to generate a blended picture comprising information blended from the current picture and the reference picture; and output the blended picture.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for processing video data, the method comprising:
obtaining a current picture of video data;
determining a noise level in the current picture; and
selectively applying Motion Compensated Temporal Filtering (MCTF) to the current picture based on the noise level.

2. The method of claim 1, wherein selectively applying the MCTF further comprises:
comparing the noise level in the current picture with a threshold; and
applying the MCTF to the current picture, in response to determining that the noise level in the current picture is greater than the threshold.

3. The method of claim 1, wherein selectively applying the MCTF to the current picture comprises:
estimating motion data between the current picture and a reference picture;
applying, based on the motion data, a temporal filter to generate a blended picture comprising information blended from the current picture and the reference picture; and
outputting the blended picture.

4. The method of claim 3, wherein selectively applying the MCTF to the current picture further comprises:
aligning the current picture with the reference picture based on the motion data.

5. The method of claim 3, wherein selectively applying the MCTF to the current picture further comprises:
applying the MCTF to the current picture using one or more control signals.

6. The method of claim 3, wherein estimating the motion data comprises:
estimating the motion data using a sum of absolute difference (SAD) technique.

7. The method of claim 3, wherein estimating the motion data comprises:
identifying motion patterns indicating ghosting.

8. The method of claim 1, wherein the noise level comprises a noise profile.

9. An apparatus configured to process video data, the apparatus comprising:
a memory; and
processing circuitry in communication with the memory, the processing circuitry configured to:
obtain a current picture of video data;
determine a noise level in the current picture; and
selectively apply Motion Compensated Temporal Filtering (MCTF) to the current picture based on the noise level.

10. The apparatus of claim 9, wherein to selectively apply the MCTF to the current picture, the processing circuitry is further configured to:
compare the noise level in the current picture with a threshold; and
apply the MCTF to the current picture, in response to determining that the noise level in the current picture is greater than the threshold.

11. The apparatus of claim 9, wherein to selectively apply the MCTF to the current picture, the processing circuitry is further configured to:
estimate motion data between the current picture and a reference picture;
apply, based on the motion data, a temporal filter to generate a blended picture comprising information blended from the current picture and the reference picture; and
output the blended picture.

12. The apparatus of claim 11, wherein to selectively apply the MCTF to the current picture, the processing circuitry is further configured to:
align the current picture with the reference picture based on the motion data.

13. The apparatus of claim 11, wherein to selectively apply the MCTF to the current picture, the processing circuitry is further configured to:
apply the MCTF to the current picture using one or more control signals.

14. The apparatus of claim 11, wherein to estimate the motion data, the processing circuitry is further configured to:
estimate the motion data using a sum of absolute difference (SAD) technique.

15. The apparatus of claim 11, wherein to estimate the motion data, the processing circuitry is further configured to:
identify motion patterns indicating ghosting.

16. The apparatus of claim 9, wherein the noise level comprises a noise profile.

17. The apparatus of claim 9, further comprising a camera sensor configured to capture the current picture of the video data.

18. Non-transitory computer-readable storage media having instructions encoded thereon, the instructions configured to cause processing circuitry to:
obtain a current picture of video data;
determine a noise level in the current picture; and
selectively apply Motion Compensated Temporal Filtering (MCTF) to the current picture based on the noise level.

19. The non-transitory computer-readable storage media of claim 18, wherein the instructions to selectively apply the MCTF to the current picture are further configured to cause the processing circuitry to:
compare the noise level in the current picture with a threshold; and
apply the MCTF to the current picture, in response to determining that the noise level in the current picture is greater than the threshold.

20. The non-transitory computer-readable storage media of claim 18, wherein the instructions to selectively apply the MCTF to the current picture are further configured to cause the processing circuitry to:
estimate motion data between the current picture and a reference picture;
apply, based on the motion data, a temporal filter to generate a blended picture comprising information blended from the current picture and the reference picture; and
output the blended picture.
